(19) United States
(12) Patent Application Publication
(10) Pub. No.: US 2003/0168396 A1
(43) Pub. Date: Sep. 11, 2003

(54) MONOLITHIC FILTER BODY AND FABRICATION TECHNIQUE

(76) Inventor: James D. Jacobson, Lindenhurst, IL (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/250,020

(22) Filed: May 29, 2003

Related U.S. Application Data
(63) Continuation-in-part of application No. 09/457,173, filed on Dec. 8, 1999.
(60) Provisional application No. 60/388,049, filed on Jun. 12, 2002.

(51) Int. Cl. B01D 29/00

(52) U.S. Cl. 210/321.75; 210/483

(57) ABSTRACT

A filter having a monolithic filter body having pores, cavities, and cavity side walls disposed between and formed integrally with first and second spaced apart faces of the filter body and providing structural support therefor. A method of fabrication thereof involving molding using mold halves, and a flowable, curable material to form the monolithic filter body. A method of fabricating such mold halves.

### REFERENCE TO RELATED APPLICATIONS

This application claims priority from provisional U.S. Pat. App. No. 60/388,049 filed Jun. 12, 2002, and is a continuation-in-part of U.S. Pat. App. Ser. No. 09/457,173 filed 8 Dec. 1999.

### BACKGROUND OF THE INVENTION

The present invention relates generally to microporous filters and to methods of making microporous filter bodies. More particularly, the invention relates to microporous filter bodies fabricated using flowable materials such as a polydimethylsiloxane elastomer, and to using a mold to make filter bodies, and to a method of making such a mold.

One type of filter provides a tortuous path through which particles must navigate to pass. Such filters are sometimes referred to as depth filters and typically use a filter body made of a thick bed of fiber or other material. Due to their thickness and tortuous path filtration technique, these filters sometimes require relatively high transfilter pressures to facilitate flow through the filter. These depth filters also exhibit rather weak selectivity, which is to say that there is, for example, unexceptional discrimination or that there is a range of particle sizes that pass through.

Another type of filter employs relatively thin filter bodies, which typically have nominal pore sizes. Such filter bodies have been used in a wide variety of medical and industrial applications. For example, such filter bodies, with nominal pore size as low as 0.22 microns, have been used to filter bacteria and other matter from liquids, such as intravenous solutions. Such microporous filters also have been used to separate the cellular components of human blood (red cells, white cells, and platelets) from liquid plasma in which the components are suspended. One device for carrying out such separation of blood components is the Autopheresis-CÂ® separator distributed by Baxter Healthcare Corporation of Deerfield, Ill.

Although nominal pore size filter membranes have functioned generally satisfactorily, they tend to have limited porosity, discriminate principally on the basis of size alone, and sometimes suffer from reduced flow rates due to blockage on the surface of the membrane. “Porosity,” as used here, refers to the portion or percentage of the membrane surface made up of pores. This may also be referred to as the membrane “transparency.” A high porosity or transparency filter membrane, i.e., one in which a large portion of its surface is made up of pores, tends to allow higher flow rates through the filter membrane at a given transfilter pressure than a low porosity or transparency membrane, i.e., one in which a small portion of its surface is made up of pores.

More recently, efforts have been directed to developing filters having precise pore sizes and shapes for increased discrimination, particularly at the micron and sub-micron scale for the separation of, for example, cells and cell components. Such filters may have particular, but not exclusive, application in the separation of blood cells or other types of cells from one another or from the liquid (plasma in the case of blood cells) in which they are suspended.

Filters with micron or smaller scale pores, however, often have significant limitations. One such filter membrane is referred to as a “trac-etched” membrane. A trac-etched membrane has holes or pores of uniform micron-scale diameter for discrimination based on particle size. However, trac-etched membranes typically have low porosity, which limits the amount of throughput or filtration rates.

With trac-etched filters, for example, porosity tends to be between approximately two percent and six or seven percent. Attempts to increase porosity in trac-etched filter membranes often results in doublets or triplets, which are holes that overlap and therefore reduce the discrimination of the filter membrane. To avoid doublets or triplets, porosity in trac-etched membranes is typically limited to about seven percent and less. Also, trac-etched membranes have only circular pores and are therefore not suitable for discriminating based on non-circular particle shape.

More recently, it has been suggested to use lithographic microfabrication or similar micromachining techniques to provide filter bodies in which the pores have precise size and shape. U.S. Pat. No. 5,651,900, for example, discloses a particle filter made of inorganic material, such as silicon, that is suitable for use in high temperatures and with harsh solvents. The filter has precisely controlled pore sizes formed by interconnecting members, and has optional reinforcing ribs.

Precise pore size filter bodies have also been proposed, for example, for separating one class of blood cells from another. U.S. Pat. Nos. 6,491,819 and 6,497,821 entitled “Method and Apparatus for Filtering Suspensions of Medical and Biological Fluids or the Like,” hereby incorporated by reference herein, describe such filter membranes having precise micron-scale and precision-shaped pores that can be used, for example, to separate red cells from white cells in human blood.

In this example, the shape of the pores (ovals) allows discrimination between cells of differing mechanical or deformation properties (e.g., red blood cells and white blood cells are roughly the same size, but red cells are mechanically similar to water balloons whereas white cells are more like golf balls). Both red and white blood cells can deform to fit through the slot or oval pores but the white cells are three orders of magnitude slower in this deformation. Thus, in the spinning environment, the white blood cells get swept away from the filter surface by Taylor vortices before they squeeze through.

The direct manufacture of microstructures via traditional surface micromachining techniques, such as single-layer filter membranes by microlithography, micromachining, or similar processes suffers from several constraints. For example, the diameter or largest transverse dimension of the pores can typically be no smaller than about one half or one third of the thickness of the filter body itself. Therefore, very small pore sizes, such as one micron or less, require very thin membranes of 2 to 3 microns or thinner. The inverse of this is commonly known as the “aspect ratio” and generally means that the thickness can be no more than about 2 or 3 times the pore diameter. Such thin bodies are typically fragile and may not be sufficiently robust for many uses of microporous filter membranes.

A detailed description of the Autopheresis-C device may be found in U.S. Pat. No. 5,194,145 to Schoendorfer, incorporated by reference herein. The Autopheresis-C separator employs a membrane mounted on a spinning rotor within a stationary housing. This device is particularly efficient at separating blood cells from the plasma in which they are suspended. The membrane used in such a device must be flexible and able to withstand the high rotational speeds, shear forces, and transmembrane pressures encountered in such a separation system.

Microfabrication of microporous filter bodies has been limited by competing considerations. In one aspect, finer filtration (smaller pore size) typically requires a filter body that is increasingly thin, and thus increasingly fragile. In another aspect, the desire for robustness has generally been met by thicker filter bodies that do not typically permit the formation of high porosity very small, precisely controlled pores.

U.S. Pat. No. 5,753,014 to Van Rijn describes a composite membrane having a polymeric membrane layer atop a separate polymeric macroporous support. The perforations or pores in the membrane layer and in the support are made by a micromachining process, such as a lithographic process in combination with etching. An intermediate layer may be deposited between the membrane and support for bonding enhancement and stress reduction. Although such a membrane may be suitable for some applications, it remains a relatively expensive membrane to fabricate, using small volume processes.

Very thin microporous membranes having micron-scale pores are also found in non-filtration applications. For example, published International Application No. WO 96/10966, published Apr. 18, 1996, discloses a microfabricated structure for implantation in host tissue. The structure is made up of a series of polyimide polymer membrane layers, each having a different geometric pattern of holes formed by a microfabrication technique. As a result of stacking these membranes together, a porous three-dimensional structure is created that promotes the growth of vascular structures in a host.

There remains a need for improved microporous filter bodies, for improved methods for making such filter bodies, and for apparatus employing such membranes.

### SUMMARY OF THE INVENTION

Briefly, therefore, a method of fabricating a monolithic filter body embodying aspects of the invention includes mating a first mold half with a second mold half to form a mold configured for forming a monolithic filter body including at least one cavity, cavity side walls providing a support structure, and pores. The method also involves curing a flowable, curable material in the mold to form the monolithic filter body, and removing the monolithic filter body from the mold.

A method of fabricating a mold half embodying aspects of the invention involves forming a pattern of etch-resistant material on a mold-half mold substrate, etching material from the mold-half mold substrate as defined by said pattern to provide a form corresponding to features of the filter body, and stripping the etch-resistant material from the first-mold-half mold substrate to form the mold half.

A filter embodying aspects of the invention includes a monolithic filter body having first and second spaced apart faces extending generally transverse to a direction of flow. The filter has at least one cavity extending from the second face toward the first face and having a cavity depth, and cavity side walls formed integrally with the first and second spaced apart faces and providing structural support for the monolithic filter body. There are also a plurality of pores extending from the first face to the at least one cavity.

Other aspects and features will be in part apparent and in part pointed out hereinafter.

### BRIEF DESCRIPTION OF THE DRAWINGS

FIG. 1 is a perspective view of a filter of the invention.

FIG. 2 is an exploded perspective view of the filter of FIG. 1.

FIG. 3 is a cross-section of the filter of FIGS. 1 and 2.

FIG. 4 is a view illustrating a step in the process of making a filter mold of the invention.

FIGS. 5 and 6 are patent side elevations of opposite filter mold halves.

FIG. 7 is a partial side elevation of mating filter mold halves with filter molding material therein.

FIGS. 8-12 are views illustrating steps in the process of making a different filter mold of the invention.

FIG. 13 is a partial side elevation of a filter mold half made in accordance with the steps of FIGS. 8-12.

FIG. 14 is a partial side elevation of mating filter mold halves with filter molding material therein.

FIG. 15 is a schematic illustration of a separator incorporating the filter body of the invention.

### DETAILED DESCRIPTION OF PREFERRED EMBODIMENTS

Commonly owned U.S. patent application Ser. No. 09/457,173, filed on Dec. 8,1999, is incorporated herein by reference.

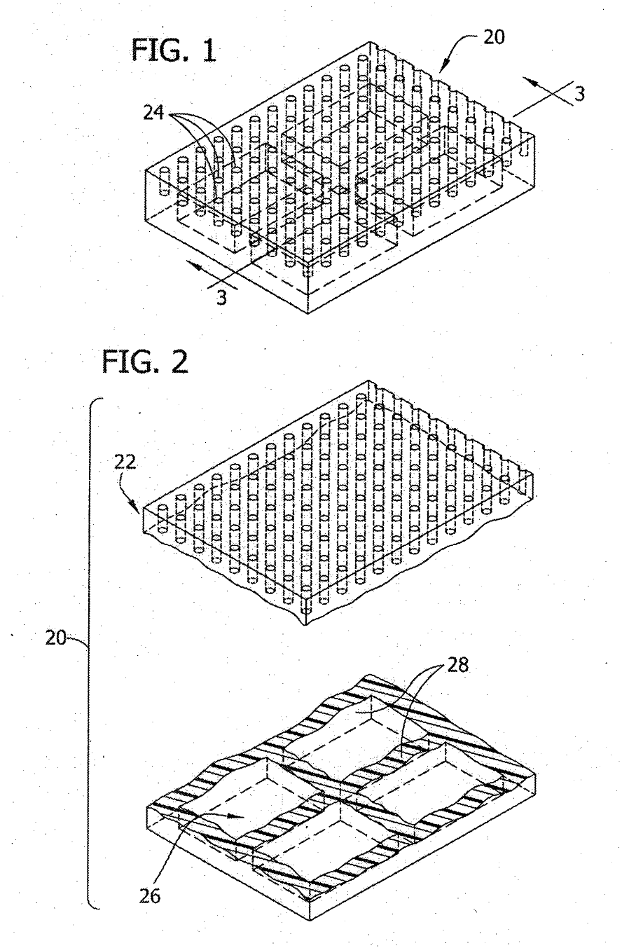

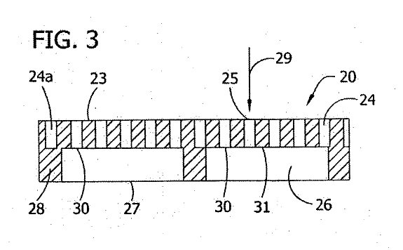

One embodiment of a monolithic filter body of the invention is illustrated generally at 20 in FIGS. 1-3. The filter body has a plurality of small, dense, precisely defined pores 24 and at least one cavity 26 with cavity side walls 28. Four such cavities 26 are shown in the embodiment of FIGS. 1-3, but this number can vary. As best illustrated in FIG. 3, the pores 24 have openings 25 on a first face 23 of the filter, which is the top face as oriented in FIG. 3. The pores extend from this first face toward a second face 27, which is the bottom face of the filter as oriented in FIG. 3. The first face and second faces are spaced apart and disposed generally transverse to a direction of flow 29 through the filter body. The cavities 26 extend from the second face 27 toward the first face 23 and terminate in a bottom surface 30 short of the first face in such a manner that the cavity side walls are formed integrally with these faces.

Most of the pores 24 shown in FIGS. 1-3 extend from the first face 23 of the filter body 20 to the bottom surfaces 30 of respective cavities 26. On the other hand, some pores may not communicate with the cavities but rather terminate as blind holes 24a at the cavity side walls 28. These latter passages do not serve to convey fluid through the filter, because they are obstructed by the cavity side walls.

Within a path of flow, the filter may be oriented so that either the first face 23 or the second face 27 is the upstream face with respect to the flow of fluid or other material to be filtered. The cavities 26 permit the unobstructed flow of fluid or other material to or from the pores 24, depending on whether the first face or the second face is first contacted by the flowing material.

The cavity side walls 28 provide structural support for the overall filter body 20, and permit a large percentage of the area of the first face 23 to be occupied by pore openings rather than by mechanical support. This permits incorporation of a larger number of pores, and thus higher flowrates, and lower transfilter pressures. These supporting side walls, in conjunction with the monolithic nature of the filter body, provide sufficient strength to the overall filter body to overcome the above-described strength problems, and permit the filter body to be manufactured to be especially thin. In particular, these features permit the pores to be especially short or shallow in the direction of flow 29, to overcome the above-described porosity problems and transfilter pressure problems.

The embodiment illustrated in FIGS. 1-3 is shown schematically and is not drawn to scale. With regard to the dimensions of the pores, for example, a typical range for the diameter of the pores 24 is between about 0.1 Î¼ m and about 15 Î¼ m. One preferred range for the diameter of the pores is between about 0.1 Î¼ m and about 0.5 Î¼ m. In one example the pores 24 have a diameter of about 0.2 Î¼ m. Another preferred embodiment employs pores with a diameter or equivalent dimension in the range of about 1 to about 12, e.g., ovals being about 2-3 microns across in the shortest dimension transverse to flow and about 6-12 microns across in the longest dimension transverse to flow. Considering that the invention is directed to filter bodies which have pores of non-circular (e.g., square, oval, rectangular) as well as circular cross-section, it is useful to also consider pore size in terms of cross-sectional area in a plane transverse to the direction of flow therethrough, because there is not always, strictly speaking, a diameter. In this regard, a typical range for the cross-sectional area of the pores 24 is between about 0.008 Î¼ m 2 and about 175 Î¼ m 2. One preferred range for the cross-sectional area of the pores is between about 0.008 Î¼ m 2 and about 0.2 Î¼ m 2. In one example the pores 24 have a cross-sectional area of about 0.03 Î¼ m 2. In another example the pores have a cross-sectional area between about 28 Î¼ m 2 and about 110 Î¼ m 2.

The pores typically have an average depth in the direction of particulate flow therethrough of between about 0.1 Î¼ m and about 10 Î¼ m. In one preferred embodiment, the pores have an average depth between about 0.1 Î¼ m and about 1 Î¼ m. In another preferred embodiment, the pores have an average depth between about 1 Î¼ m and about 10 Î¼ m. In one example the pores have a depth of about 1.5 Î¼ m. In the example described above with oval pores, the depth is on the order of about 2-3 microns. The pores have a typical aspect ratio (ratio of depth to diameter) of about 2 to about 40. In one preferred embodiment, the aspect ratio is less than about 10. In another preferred embodiment it is less than about 5. One example has an aspect ratio of about 2.5. As to the frequency of the pores 24, for example, they are on the order of about 0.6 Î¼ m apart and are concentrated to a density of about two to three pores per square Î¼ m.

As to the cavity dimensions, in one preferred embodiment the cavities 26 and the cavity side walls 28 have an average depth in the direction of flow therethrough of between about 5 Î¼ m and about 200 Î¼ m. In another preferred embodiment the cavities and cavity side walls have an average depth in the direction of flow of between about 5 Î¼ m and about 50 Î¼ m. In another preferred embodiment, the cavities have an average depth between about 50 Î¼ m and about 200 Î¼ m. In one example the depth of the cavity 26 and of the cavity side walls 28 is about 100 Î¼ m. The length of each cavity side wall is on the order of between about 100 Î¼ m and about 10 mm. In one example the dimension of cavity 26 is about 1 mm by 1 mm by 100 Î¼ m. The cavity walls 28 have an average thickness of preferably between about 1 Î¼ m and about 100 Î¼ m. In another preferred embodiment, the cav thickness between about 1 Î¼ m and about 10 Î¼ m. In another preferred embodiment, the cavity walls have an average thickness between about 10 Î¼ m and about 100 Î¼ m.

Accordingly, further to the example, the portion of the filter body comprising the pores 24 is on the order of 1.5 Î¼ m thick and spans a desired distance between the ribs (cavity side walls 28) of, for example, on the order of 1 mm.

The foregoing respective parameters are interdependent and the selection of one parameter is not made without consideration of other parameters. Consequently, it will be understood that certain combinations of parameters within these dimensions will not be appropriate; for example, an especially large pore depth within these ranges of 10 Î¼ m is not used with an especially small pore diameter within these ranges of 0.1 Î¼ m. Rather, dimensions are interdependently selected to provide an overall product which achieves the desired filtration goals within manufacturing capabilities. Moreover, while these dimensions are critical to specifically preferred embodiments â [symbol] e.g., specific dimensions and geometries are required to separate white and red blood cells â [symbol] these dimensions are not narrowly critical to the overall inventive concept of the monolithic filter body and method of manufacture.

The filter body advantageously can have a relatively high porosity. For example, the filter body may optionally have a porosity level in the range of about 15% to about 65%, and optionally of at least about 30%. Where desired for a specific application, however, the porosity of the filter body can be much lower.

The manner of forming the pores described below facilitates the foregoing advantages and permits precise geometric control of the pore dimensions for precise separation of, for example, plasma, platelets, or white blood cells from blood or blood products.

The method of the invention involves molding the portion of the filter body which contains the pores simultaneously with molding the portion of the filter body which contains the cavities. This yields a monolithic filter body of enhanced strength and integrity in comparison to filters having a separately formed support structure and pore structure.

In one aspect this invention is directed to preparing a mold comprising a pair of mold halves for use in making the monolithic filter body of the invention. In preparing the mold halves in one exemplary embodiment, one substrate, such as a silicon wafer, is prepared as a first mold half for molding the portion of the filter body containing the pores. A second substrate is prepared as a second mold half for molding the portion of the filter body containing the cavities and cavity walls. As used herein, the term “mold halves” means any number of mold parts which unite to form a mold to carry out a molding process and which are separable to remove a molded article from the mold. The term “half” is not limited to a mold part which corresponds to one half of the mold in any literally quantitative sense, nor is it necessarily responsible for molding one half of the monolithic filter body.

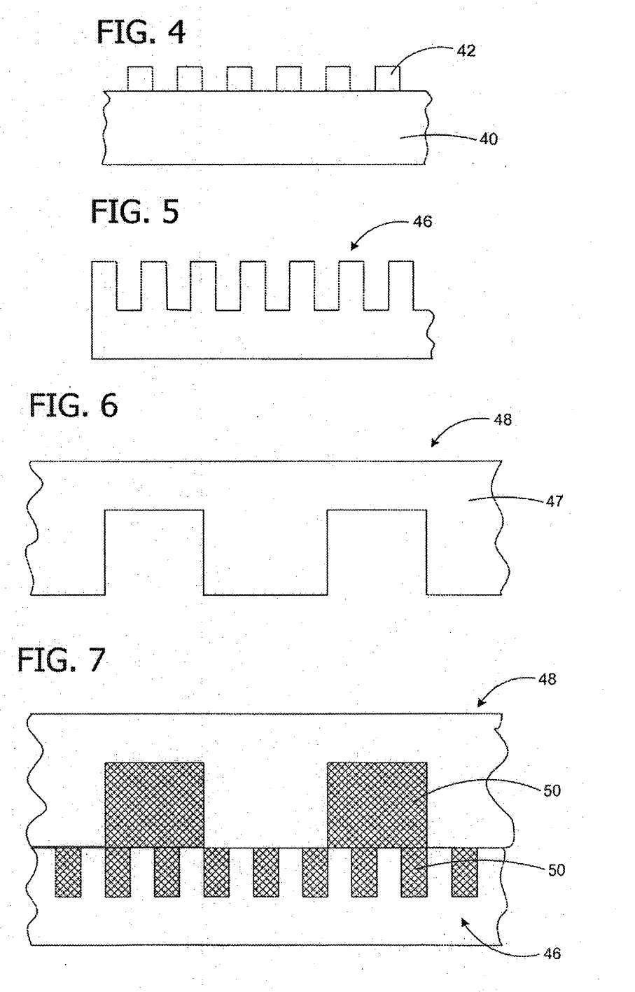

FIG. 4 illustrates a first step in forming a mold half in one exemplary embodiment. A photoresist composition is deposited onto substrate 40 (e.g., a silicon wafer) and developed to provide pattern of etch-resistant material 42. Those skilled in the art are familiar with photolithography and the use of photoresist compositions. The pattern is preferably formed by depositing the photoresist composition over the entire substrate, then developing it by exposure to UV light through a mask defining the desired pattern. The unwanted photoresist composition, whether positive tone or negative tone, is rinsed away, leaving an etch-resist pattern 42 on the substrate 40. Following the rinse step, a reactive ion etching process is applied, which removes a layer of substrate in areas not protected by the etch-resist pattern 42. Suitable etching systems are available from Alcatel Vacuum Technology, Robert Bosch GmbH, Surface Technology Systems (STS), Applied Materials, and other suppliers to the semiconductor and microelectromechanical systems (MEMS) industries. The etch-resistant material is then removed by solvent dissolution or a dry chemical ashing or etching process to yield the mold half 46 illustrated in FIG. 5, which mold half defines the pores to be molded into the monolithic filter body.

Another mold half 48 (FIG. 6) which defines the cavities 26 and cavity walls 28 is formed in the same manner employing another silicon substrate 47. The respective mold halves provide forms corresponding to the components of the filter body.

As the cavities are much deeper than the pores in this embodiment of the invention, deep reactive ion etching (DRIE) is well suited for accomplishing the etch. DRIE systems are available from STS and Alcatel Vacuum Technology. U.S. Pat. No. 5,501,893 discloses one suitable approach to the DRIE process. A number of other approaches known in the art are also acceptable. The DRIE process allows a direct pattern transfer from the photoresist layer into the substrate (i.e., vertical sidewalls as shown).

The etch can also be accomplished by more traditional “wet etch” approaches that would result in anisotropic profiles. In the wet etch embodiment, it is to be understood that an additional protective layer supports the etch because photoresist is generally not robust enough to survive TMAH or KOH etching for deep structures. For example, a silicon dioxide layer is thermally grown on the silicon substrate prior to the lithographic process. The desired pattern is then transferred to the oxide layer and subsequently to the substrate with the oxide assuming the role of the etch mask. The oxide is then removed or left in place.

With the respective mold halves so formed, the monolithic filter body is molded as illustrated schematically in FIG. 7. In one procedure, the process involves first mating the mold halves 46 and 48 and subsequently filling with a flowable, curable material 50 either by capillary action or by use of runners (not shown) leading to the cavities 26 in the mold halves. In an alternative procedure, the mold halves are filled first and then mated.

In one embodiment, the flowable, curable material is an elastomeric material. One preferred material is polydimethylsiloxane (PDMS) elastomer, which is available, for example, from Dow Corning Corporation of Midland, Mich. under the trade designation Slygard 184. Other flowable, castable materials which can be used include rubber, plastic, and silicone materials. In addition to flowability and castability, it is preferable that the material also have moderate flexibility. After curing, the material should not be so brittle that it cracks upon routine handling in manufacturing, installation, and use of the filter. For many medical applications or the like, such as filtering of blood products, the material should be biocompatible and governmentally approved as such. The flowable, castable material should be selected so that it has good release properties from the mold, and such that it has low shrinkage in the cure process for dimensional stability.

With some flowable, castable materials it is also desirable to employ a compatible curing agent. For example, as described in Jo et al., Three-Dimensional Micro-Channel Fabrication in Polydimethylsiloxane (PDMS) Elastomer, Journal of the Microelectromechanical Systems, Vol. 9, No. 1, Mar. 2000 (page 77), the Slygard 184 Silicon Elastomer Kit available from Dow Corning of Midland, Mich. employs a curing agent in a 1:10 weight ratio with PDMS prepolymer.

The flowable, castable material is permitted to cure or at least partially cure in the mold, after which the mold halves are separated and the monolithic filter body is removed from the mold. The specific molding and curing parameters such as pressure, time, and temperature vary depending on the specific flowably, castable material selected. For example, Jo et al. describe molding and curing under simply clamping under 0.5 pound (227 grams) and 4 pound (181 grams) for 3 hours at 100° C.

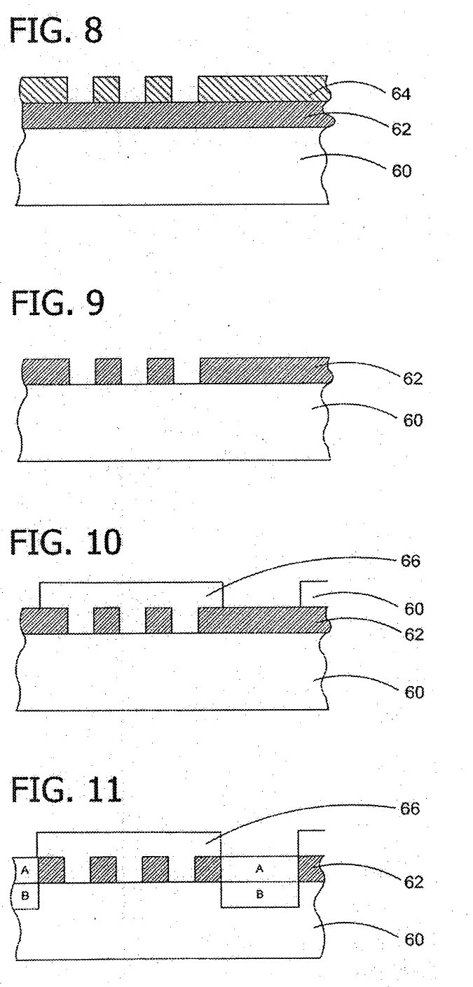

In an alternative embodiment, the pores 24, cavity or cavities 26, and cavity walls 28 are all defined by the same mold half. A mold half of this type is depicted at 80 in FIGS. 13 and 14. A preferred method of making the mold half 80 is illustrated in FIGS. 8-12. Referring to FIG. 8, an oxide layer 62 is grown on a mold substrate 60 after which an etch resist 64 is applied over the oxide layer 62 in the same manner described above for the etch resist 42 in FIG. 4. As in the previous embodiment, this substrate may be a silicon wafer. The etch resist 64 defines a pore pattern which is then etched into the oxide layer 62. The etch resist 64 is removed after the etching step to yield the mold substrate 60 with a pore pattern in the oxide layer 62, as depicted in FIG. 9.

Referring to FIG. 10, a further etch resist layer 66 is built in a pattern to define the cavities 26 and cavity walls 28 in the eventual mold in the same manner as described above. Regions A and B in FIG. 11 are then etched away to define the locations of the cavities and cavity walls. In a preferred embodiment, the relatively thin etched oxide of region A is removed by plasma etching, and the deeper silicon region B is removed by DRIE. Region B is etched to a depth corresponding to the desired depth of the eventual cavities and cavity walls.

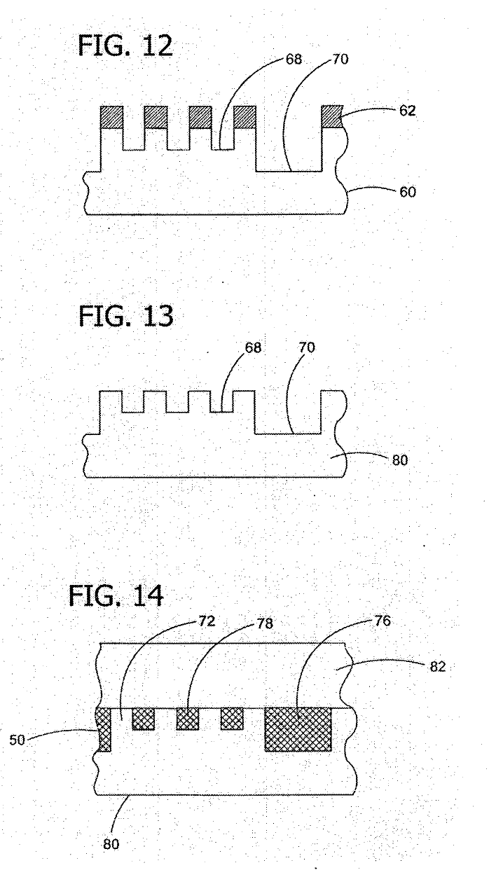

Turning to FIG. 12, the etch resist 66 is removed by, for example, solvent dissolution or dry ashing or etching. The oxide 62 then serves as an etch resist, and the substrate 60 is exposed to further etching, preferably etching by reactive ion etching. At a uniform etch rate, this etching operation is performed sufficiently long to add only the desired depth to the pore preforms 68 beneath the oxide layer, which inherently adds an appropriate depth to the cavity preforms 70. The oxide layer 62 is then removed, for example, by etching with HF, to yield the mold half 80 of FIG. 13.

As illustrated schematically in FIG. 14, the process involves mating the mold halves in that mold half 80 is brought into communication with a solid or blank mold half 82 to provide a mold to retain a flowable, curable material in forming the monolithic filter body. The portion of the mold which forms a pore in the eventual filter body is shown at 72. The material which forms a cavity side wall in the eventual filter body is shown at 76. The material which forms the filter body between the pores is shown at 78. This arrangement yields a filter body which does not have the blind holes 24a of the filter body in FIG. 3. In one procedure, the mold halves 80 and 82 are brought together first and mold half 80 is subsequently filled with a flowable, curable material 50 either by capillary action or by use of runners (not shown) leading to the cavities in the mold half. In an alternative procedure, mold half 80 is filled first and then brought into communication with mold half 82. In this alternative procedure the flowable, curable material is more of a sticky blob or lump of material which does not fall out of the mold halves before they are brought into communication.

In one embodiment of the foregoing procedure, the oxide layer 62 is, for example, on the order of about 0.1 micron thick, the photoresist layers 64, 66 are on the order of one micron thick, and the deeper etch of region B is on the order of about 25 microns. In the eventual mold half 80 shown in FIG. 13, the preforms 68 for the pores have a depth between about 0.5 Î¼ m, and about 5 Î¼ m, and the preforms 70 for the cavities and cavity walls have a depth between about 10 Î¼ m and about 200 Î¼ m, for example. These dimensions are illustrative only, and can be modified to form various alternative dimensions in a filter body.

These various figures reflect only segments of mold components, and a much wider periodic structure is usually preferred for forming a much wider filter body, even much wider and with many more periods than the filter body of FIGS. 1-3.

The preparation and use of molds as described above facilitates reuse of the mold halves, such that one set of mold halves is used for fabricating a large number of filter bodies. Consequently, this technique provides a low-cost manner by which to fabricate these filter bodies, in contrast to prior fabrication techniques which micromachined or similarly formed individual filters without the benefit of a reusable mold.

In view of the above, it will be seen that the several aspects of the invention are achieved and other advantageous results attained. In particular, the precise method of manufacture permits precise control of the size of the pores. Small diameter pores are formed, such that microfiltration can be accomplished without employing a thick filter, thereby avoiding the problems of clogging and high transfilter pressure. Moreover, the present invention exhibits high discrimination as the pore size is defined by lithography, which is a well controlled process. The pores can be molded in a wide variety of shapes, thereby permitting filtration based on particle geometry or deformation rates in addition to particle size. For example, rectangular pores can be used to help prevent clogging in certain applications. Circular pores can be used for separating in media with vulnerable particles. Oval pores can be used to separate white and red blood cells. Shallow pores with rounded and smooth morphology are especially appropriate for separating biological cells. The filter bodies optionally have high porosity and high throughput with high filtration rates. The filter bodies are seamless in that each constitutes a one-piece molded mass without. seams (“seams” not encompassing molding parting lines). The filter bodies are robust and can optionally be made to withstand high rotational speeds, high shear forces, and high transfilter pressures. The filter bodies are relatively simple to manufacture and are monolithic filter bodies such that there is advantageously no intermediate layer between the pores and the support structure. The monolithic nature eliminates any risk of delamination of the pore structure from the support structure, and eliminates any issue with regard to compatibility with regard to stress, temperature, and other aspects. The present invention also allows precise control of filter bodies having a low porosity, if desired.

The filter body of the present invention may be employed in a separator for separating particles such as, but not limited to, cells from a liquid or suspension. Examples of such separators are disclosed in co-assigned U.S. Pat. Nos. 6,491,819 and 6,497,821, the disclosures of which are expressly incorporated herein by reference. For example, in accordance with this further aspect of the present invention, a separator may be provided comprising a housing including a fluid inlet and a first fluid outlet, with a flow path defined in the housing between the inlet and first outlet. A monolithic filter body of the present invention may be located within the housing in the flow path to filter fluid (filtrate) passing therethrough.

In such a separator, the filter body may be disposed in such a position and shaped as is reasonably needed for the particular application. For example, the filter body in one embodiment is disposed across the flow path so as to filter particles, including but not limited to cells or cell fragments, from the liquid being filtered. Alternatively, the filter body is positioned along the length of the flow path so that fluid from which filtrate is removed flows across the surface of the body. In this alternative, a second outlet would typically be provided to remove that portion of fluid not passing through the filter body.

Because of the flexible, robust character, the filter body of the present invention, in one of its preferred forms, is positioned in a separator in a curved disposition. These characteristics of the filter body of present invention make it particularly suitable for use in the type of device that separates a liquid or suspension by passing it between two relatively rotating structures. Such a device is exemplified by the Autopheresis-C separator sold by Baxter Healthcare Corporation.

The Autopheresis-C separator includes a generally cylindric housing, a co-axial cylindric rotor in the housing, and a filter covering the perforated cylindric surface of the rotor and spread from the housing to define an annular gap. A suspension, such as blood, is passed from one end of the housing to the other end, through the gap between the filter and housing surfaces. Plasma flows through the porous body of the filter, through the perforated surface of the rotor, and exits through an outlet in the housing. As noted earlier, this type of separator has been found to be very efficient for separating the cellular components of human blood from the plasma in which they are suspended. It is, however, a relatively high stress environment in which the filter body must not only be flexible for mounting on the cylindrical rotor or housing, but have sufficient robustness to withstand the assembly process, the high-speed rotation of the rotor (several thousand rpm), the shear forces generated by the flowing fluid, and the significant transfilter pressures that may be employed to force filtrate to flow through the filter body. The filter body of the present invention has the characteristics necessary for operating in this environment. Further, by using the high porosity filter body of the present invention, satisfactory filtrate flow rates may be obtained with lower transfilter pressures than are presently used.

One of the aspects of the AutopheresisC device is that the relative rotation between the rotor and housing creates a series of strong vortex cells in the gap, known as Taylor Vortices. The Taylor Vortices sweep the surface of the filter body, helping to keep the filter body surface free of occluding particles (cells) and taking advantage of the filter body porosity. The high porosity filter body of the present invention, with the micron-scale precision-shaped pores, holds substantial promise for improving the already excellent performance of the Autopheresis-C device.

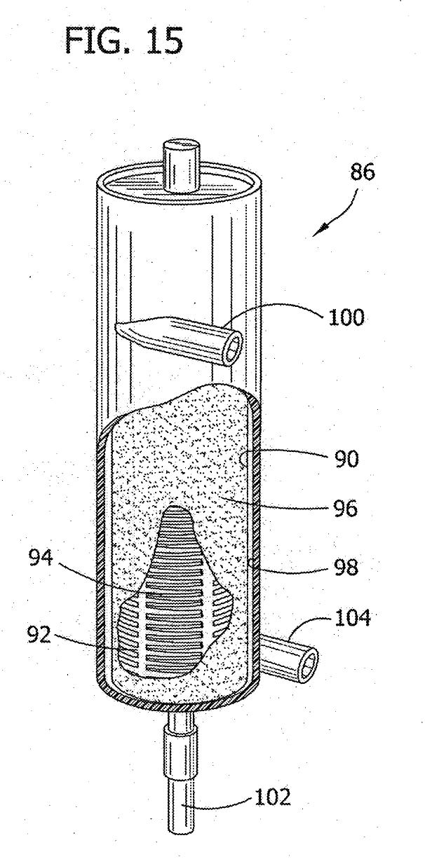

Therefore, in accordance with present invention, a separator may be provided for separating one or more components of liquid or suspension. One embodiment of such a separator is shown schematically in FIG. 15. The separator 86 includes a housing 88 having a generally cylindrical interior surface 90 and a rotor 92 rotatably mounted within the housing and having a generally cylindrical outer surface 94 spaced from the interior surface of the housing (or both). A flexible monolithic filter body 96 in accordance with present invention is disposed on the generally cylindrical surface 94 of the rotor 92 thereby defining an annular gap 98 for the flow of fluid through the housing 88. The filter body 96 is alternatively disposed on the generally cylindrical interior surface 90 of the housing, or both on the generally cylindrical surface 94 of the rotor and on the generally cylindric interior surface 90 of the housing. The filter body includes micron-scale precision-shaped pores and a support structure including a precision-shaped cavities and robust cavity walls as support structure for the pores, as described above. Whether mounted on the rotor or housing, the pores are positioned to face the gaps between the rotor and housing. In other words, if the filter body is mounted on the rotor, the pores face the interior housing surface, and vice versa. The housing includes an inlet 100 for introducing liquid or suspension, such as blood, into the housing and a first outlet 102 for removing a portion of the suspension from the space between the rotor and housing. To remove filtrate passing through the filter body, an additional outlet 104 in the housing is provided to communicate with the cavity and cavity walls forming the support structure.

In this rotary separator application, the filter body is curved to conform to the generally cylindrical surface of the rotor or housing on which it is disposed. This may require a radius of curvature as small as on the order of about one-half inch (one cm). This radius is selected to take advantage of Taylor vortices and varies from millimeter or centimeter dimensions for laboratory scale microfiltration to meter dimensions for industrial-scale applications. As with the previously summarized separator, the size of the micron-scale pores of the filter body may be selected depending on the particular application or need.

It is understood that the filter body employed in the separators summarized above may include the more particular features and aspects summarized above with respect to the filter body without the need to repeat all of them here. For example, the separator of the present invention may include additional filter bodies to enhance flexibility and/or strength, or to provide different though cooperating pore sizes or geometries, depending on the application.

When introducing elements of the present invention or the preferred embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions and methods without departing from the scope of the invention, it is intended that all matter contained in the above description or shown in the accompanying drawings shall be interpreted as illustrative and not in a limiting sense.

1. a method of fabricating a monolithic filter body having first and second spaced apart faces extending generally transverse to a direction of flow, at least one cavity extending from the second face toward the first face and having a cavity depth, cavity side walls providing structural support for the monolithic filter body, and a plurality of pores extending from the first face to the at least one cavity, the method comprising:
mating a first mold half with a second mold half to form a mold configured for forming the monolithic filter body including said at least one cavity, said cavity side walls, and said pores;
curing a flowable, curable material in the mold to form the monolithic filter body; and
removing the monolithic filter body from the mold.

2. The method of claim 1 wherein the filter body has a porosity between about 15% and about 65%.

3. The method of claim 1 wherein the pores have an aspect ratio between about 2 and about 40.

4. The method of claim 1 wherein the pores have an aspect ratio of less than about 10.

5. The method of claim 1 wherein the pores have an aspect ratio of less than about 5.

6. The method of claim 2 wherein the pores have an aspect ratio between about 2 and about 40.

7. The method of claim 2 wherein the pores have an aspect ratio of less than about 10.

8. The method of claim 2 wherein the pores have an aspect ratio of less than about 5.

9. The method of claim 1 wherein the flowable, curable material comprises an elastomer.

10. The method of claim 1 wherein the flowable, curable material comprises PDMS elastomer.

11. The method of claim 10 wherein the filter body has a porosity between about 15% and about 65%.

12. The method of claim 10 wherein the pores have an aspect ratio between about 2 and about 40.

13. The method of claim 10 wherein the pores have an aspect ratio of less than about 10.

14. The method of claim 10 wherein the pores have an aspect ratio of less than about 5.

15. The method of claim 1 wherein the filter body has a porosity between about 15% and about 65%, wherein the pores have an aspect ratio of less than about 10, and wherein the pores have a cross-sectional area of between about 0.008 Î¼ m2 and about 175 Î¼ m2.

16. The method of claim 9 wherein the filter body has a porosity between about 15% and about 65%, wherein the pores have an aspect ratio of less than about 10, and wherein the pores have a cross-sectional area of between about 0.008 Î¼ m2 and about 175 Î¼ m2.

17. The method of claim 10 wherein the filter body has a porosity between about 15% and about 65%, wherein the pores have an aspect ratio of less than about 10, and wherein the pores have a cross-sectional area of between about 0.008 Î¼ m2 and about 175 Î¼ m2.

18. The method of claim 1 wherein the flowable, curable material comprises a material selected from among rubber, plastic, and silicone materials.

19. The method of claim 1 wherein the first mold half is configured for forming said at least one cavity and said cavity side walls, and the second mold half is configured for forming said pores.

20. The method of claim 1 wherein the first mold half is configured for forming said at least one cavity, said cavity side walls, and said pores.

21. The method of claim 1 comprising:
forming the first mold half prior to mating the first and second mold halves by a) forming a pattern of etch-resistant material on a first-mold-half mold substrate; b) etching material from the first-mold-half mold substrate as defined by said pattern to provide a form corresponding to said at least one filter cavity; and c) stripping the etch-resistant material from the first-mold-half mold substrate to form the first mold half.

22. The method of claim 1 comprising:
forming the second mold half prior to mating the first and second mold halves by a) forming a pattern of etch-resistant material on a second-mold-half mold substrate; b) etching material from the second-mold-half mold substrate as defined by said pattern to provide a form corresponding to said pores; and c) stripping the etch-resistant material from the second-mold-half mold substrate to form the second mold half.

23. The method of claim 21 comprising:
forming the second mold half prior to mating the first and second mold halves by a) forming a pattern of etch-resistant material on a second-mold-half mold substrate; b) etching material from the second-mold-half mold substrate as defined by said pattern to provide a form corresponding to said pores; and c) stripping the etch-resistant material from the second-mold-half mold substrate to form the second mold half.

24. A method of fabricating a mold half of a mold for molding a monolithic filter body having first and second spaced apart faces extending generally transverse to a direction of flow, at least one cavity extending from the second face toward the first face and having a cavity depth, cavity side walls providing structural support for the monolithic filter body, and a plurality of pores extending from the first face to the at least one cavity, the method comprising:
forming a pattern of etch-resistant material on a mold-half mold substrate;
etching material from the mold-half mold substrate as defined by said pattern to provide a form corresponding to features selected from among said pores and said at least one cavity; and
stripping the etch-resistant material from the first-mold half mold substrate to form the mold half.

25. A method of fabricating a mold half of a mold for molding a monolithic filter body having first and second spaced apart faces extending generally transverse to a direction of flow, at least one cavity extending from the second face toward the first face and having a cavity depth, cavity side walls providing structural support for the monolithic filter body, and a plurality of pores extending from the first face to the at least one cavity, the method comprising:
forming a first pattern of etch-resistant material on a mold-half mold substrate;
etching material from the mold-half mold substrate as defined by said first pattern to provide a form corresponding to said pores;
stripping the first pattern of etch-resistant material from the mold-half mold substrate;
forming a second pattern of etch-resistant material on the mold-half substrate;
etching material from the mold-half mold substrate as defined by said second pattern to provide a form corresponding to said at least one cavity;
stripping the second pattern of etch-resistant material from the mold-half mold substrate to yield the mold half.

26. A filter comprising:
a monolithic filter body having first and second spaced apart faces extending generally transverse to a direction of flow;
at least one cavity extending from the second face toward the first face and having a cavity depth;
cavity side walls formed integrally with the first and second spaced apart faces and providing structural support for the monolithic filter body; and
a plurality of pores extending from the first face to the at least one cavity.

27. The filter of claim 26 wherein the filter body has a porosity between about 15% and about 65%.

28. The filter of claim 26 wherein the pores have an aspect ratio between about 2 and about 40.

29. The filter of claim 26 wherein the pores have an aspect ratio of less than about 10.

30. The filter of claim 26 wherein the pores have an aspect ratio of less than about 5.

31. The filter of claim 27 wherein the, pores have an aspect ratio between about 2 and about 40.

32. The filter of claim 27 wherein the pores have an aspect ratio of less than about 10.

33. The filter of claim 27 wherein the pores have an aspect ratio of less than about 5.

34. The filter of claim 26 wherein the flowable, curable material comprises an elastomer.

35. The filter of claim 26 wherein the flowable, curable material comprises PDMS elastomer.

36. The filter of claim 35 wherein the filter body has a porosity between about 15% and about 65%.

37. The filter of claim 35 wherein the pores have an aspect ratio between about 2 and about 40.

38. The filter of claim 35 wherein the pores have an aspect ratio of less than about 10.

39. The filter of claim 35 wherein the pores have an aspect ratio of less than about 5.

40. The filter of claim 26 wherein the filter body has a porosity between about 15% and about 65%, wherein the pores have an aspect ratio of less than about 10, and wherein the pores have a cross-sectional area of between about 0.008 Î¼ m2 and about 175 Î¼ m2.

41. The filter of claim 26 wherein the flowable, curable material comprises a material selected from among rubber, plastic, and silicone materials.

42. The filter of claim 26 wherein the first mold half is configured for forming said at least one cavity and said cavity side walls, and the second mold half is configured for forming said pores.

43. The filter of claim 26 wherein the first mold half is configured for forming said at least one cavity, said cavity side walls, and said pores.

44. The filter of claim 26 wherein the filter body is seamless.
